(19) United States
(12) Patent Application Publication
(10) Pub. No.: US 2024/0049679 A1
(43) Pub. Date: Feb. 15, 2024

(54) RAIL CONNECTORS AND SPACERS FOR ANIMAL WHELPING CONTAINERS

(71) Applicant: EZwhelp, Inc., Duluth, GA (US)

(72) Inventor: Travis Lynn Fitz, Duluth, GA (US)

(21) Appl. No.: 18/447,992

(22) Filed: Aug. 10, 2023

Related U.S. Application Data
(60) Provisional application No. 63/397,489, filed on Aug. 12, 2022.

(51) Int. Cl. A01K 1/035; A01K 1/03

(52) U.S. Cl. CPC A01K 1/035; A01K 1/034

(57) ABSTRACT

An animal whelping box rail connector can include a connector body and a connector head. The connector body can include a tongue that is biased in a closed configuration. The tongue may be configured to at least partially flex between the closed configuration and an adjustable configuration. The tongue can include a protrusion that is configured to couple to a corresponding slot of a connector foot in the closed configuration. The connector head can include a plurality of rail receivers. Each rail receiver can be configured to receive a corresponding rail therein. The connector head may farther include a plurality of spacers each disposed opposite a corresponding rail receiver of the plurality of rail receivers. Each spacer can be configured to maintain at least a minimum distance between the connector body and a wall of an animal whelping box.

### INCORPORATION BY REFERENCE TO ANY PRIORITY APPLICATIONS

This application claims the priority benefit of U.S. Provisional Application No. 63/397,489, filed Aug. 12, 2022. The entire disclosure of the above item is hereby made part of this specification as if set forth fully herein and incorporated by reference for all purposes, for all that it contains.

### BACKGROUND

### Field of the Disclosure

This disclosure relates generally to animal whelping containers, and more particularly to rail connectors and spacers for animal whelping containers.

### Description of the Related Art

Animal whelping containers are helpful in protecting young animals, such as puppies, during birth (whelping). During early life, the animals are vulnerable and whelping containers keep them safely contained, protected from cold, and/or safe from the danger of crushing or smothering by the mother. Modern containers have deficiencies that are improved using embodiments described herein.

### SUMMARY

Embodiments described herein include systems and methods regarding animal whelping containers and components thereof. For example, an animal whelping box rail connector can include a connector body and a connector head. The connector body can include a tongue that is biased in a closed configuration. The tongue may be configured to at least partially flex between the closed configuration and an adjustable configuration. The tongue can include a protrusion that is configured to couple to a corresponding slot of a connector foot in the closed configuration. The connector head can include a plurality of rail receivers. Each rail receiver can be configured to receive a corresponding rail therein. The connector head may farther include a plurality of spacers each disposed opposite a corresponding rail receiver of the plurality of rail receivers. Each spacer can be configured to maintain at least a minimum distance between the connector body and a wall of an animal whelping box.

### BRIEF DESCRIPTION OF THE DRAWINGS

FIG. 1 shows a top plan view of an example rail connector, according to some embodiments.

FIG. 2 shows a different top plan view of the rail connector of FIG. 1.

FIG. 3 shows a top plan view of an example rail connector that includes a connector foot.

FIG. 4 shows a different top plan view of the rail connector of FIG. 3.

FIG. 5 shows a top view of the rail connector shown in FIGS. 1-2.

FIG. 6 shows a side view of a cross-section of the rail connector of FIGS. 3-4.

FIG. 7 shows the rail connector of FIGS. 3-4 that includes rails.

### DETAILED DESCRIPTION

Animal whelping containers are helpful in protecting young animals, such as puppies, during birth. This process is known as whelping. During early life, the animals are vulnerable from various dangers, and whelping containers can help keep them safely contained. They can protect the animals from fluctuations in temperature, from low or high temperatures, and/or from danger of crushing or smothering from other animals (including a mother).

Whelping containers (e.g., boxes) can be made of one or more materials and include various designs. For example, a container may include a cardboard box, a corrugated plastic, plywood, metal, or some other semi-rigid or rigid material. A whelping container can include various features that can aid in the utility for the animal or for ease in maintaining the whelping container. For example, a container may include features configured to ease cleaning and sanitation of the container, life of the box, resistance to damage, and/or modification (e.g., dimensional, size). Whelping containers can be sized to be portable by a human being and/or may be configured to be generally immovable by an animal. For example, an animal whelping container may be generally light weight, include structures for breaking down the container, and/or a rail system. The rail system can be beneficial for maintaining a position of the whelping container. Additionally or alternatively, the rail system can be helpful in preventing inadvertent crushing of the baby animals against a wall of the whelping container by the mother or some other animal.

The sides (e.g., walls) of the container may be high enough to safely contain the baby animals (e.g., puppies), prevent other (e.g., unwanted) small animals from entering, and/or low enough to allow the mother to enter and leave. The height of the walls may be tailored to a size of the mother and may include consideration for her protruding mammary glands. In some embodiments, the whelping container includes a doorway with adjustable height for this purpose. In some embodiments, a bottom of the container can include a floor. The floor can be lined with insulators, such as fabric or “whelping pads.” Such insulation can provide insulation from cold floors and/or absorb fluids.

As noted above, whelping containers can include a low railing, railing system, or rail system. These may be called “pig rails”, “roll-bars,” or some similar term. The rail system can be disposed within an interior of the container. For example, the rail system may run along an inside perimeter of the container. The rail system can protect puppies from being crushed or smothered by the mother in case she rolls over during birthing, while sleeping, or during some other instance.

A rail system can include one or more rail connectors, such as those described herein. The rail connectors can be disposed in designated points within the whelping container, such as at extremities (e.g., corners, etc.) of the inside perimeter of the whelping container.

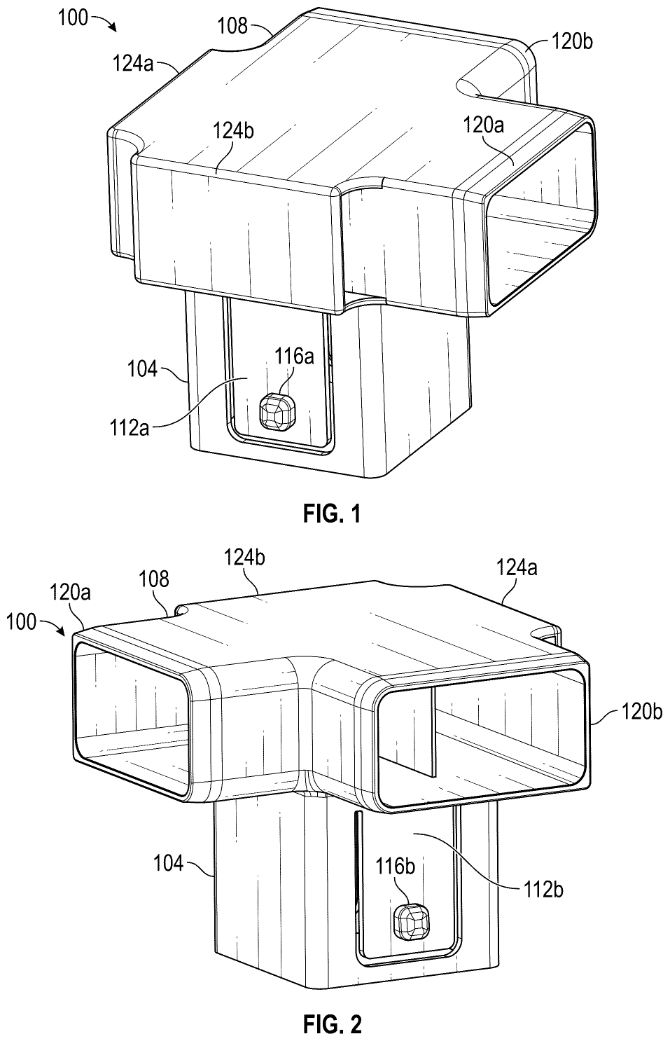

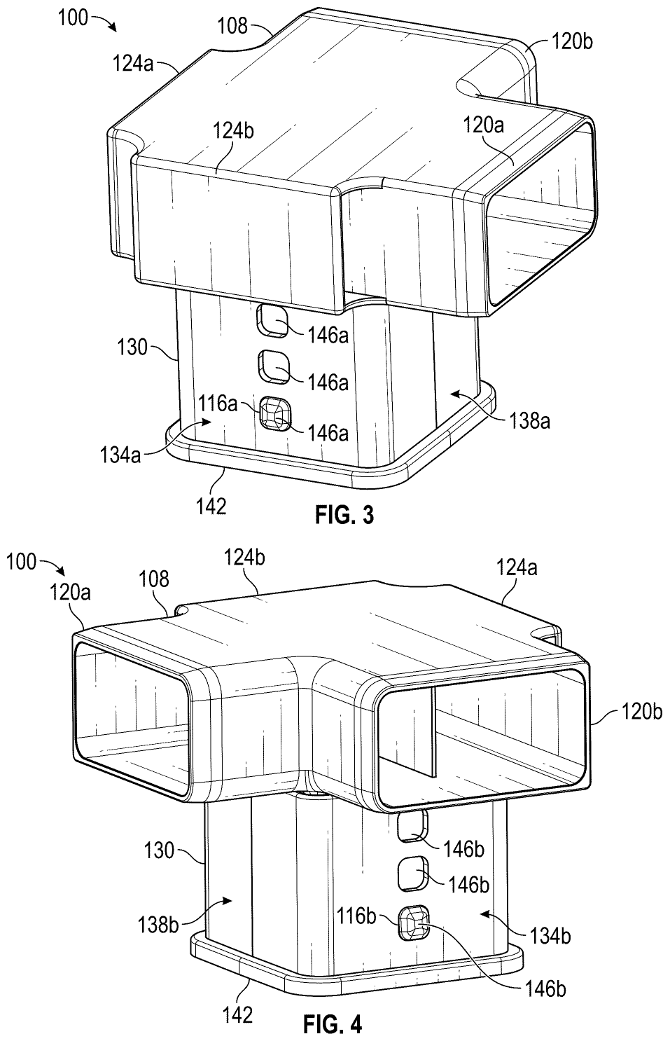

Reference will now be made to the figures. FIG. 1 shows a top plan view of an example rail connector 100, according to some embodiments. The rail connector 100 can include a connector body 104 and a connector head 108. The connector body 104 can include one or more tongues 112a, 112b. The tongues 112a, 112b may be configured to at least partially flex along a flexure arc (see FIG. 6). The tongues 112a, 112b may be biased in a closed configuration. Each of the tongues 112a, 112b can include corresponding protrusions 116a, 116b. Each of the protrusions 116a, 116b may be a button or nipple that is configured to couple with a corresponding slots 146a, 146b (see, e.g., FIGS. 3-4). The coupling between the protrusions 116a, 116b and the corresponding slots 146a, 146b can be an adjustable coupling such that the protrusions 116a, 116b can couple to different corresponding slots 146a, 146b.

The tongues 112a, 112b can be configured to move between a closed configuration and an adjustable configuration. In the closed configuration, the tongues 112a, 112b can be coupled to their corresponding slots 146a, 146b. This can create an adjustably couplable relationship between the connector body 104 and the connector foot 130. This can allow the connector body 104 to be raised or lowered, depending on a target height of the connector body 104 above a base 142 of a connector foot 130 (see, e.g., FIGS. 3-4). The corresponding slots 146a, 146b may be disposed within the connector foot 130.

With continued reference to FIG. 1, the connector head 108 can include one or more rail receivers 120a, 120b and/or one or more spacers 124a, 124b. Each of the rail receivers 120a, 120b can be configured to receive a corresponding rail therein. As shown, the each of the rail receivers 120a, 120b is shaped to receive a generally rectangular rail having rounded corners. Other shapes, such as circular rails, square rails, regular polygonal rails, and/or irregularly shaped rails, are possible. As shown, one or more of the rail receivers 120a, 120b can extend from a respective nearest surface of the connector body 104 farther than does each of the spacers 124a, 124b from their respective surfaces of the connector body 104. This extension can provide for improved support of the corresponding rail (not shown), for example to avoid slippage of the rail or undermining of the structural integrity of the connector head 108. Two of the rail receivers 120a, 120b can be neighboring such that, for example, each of the pair of rail receivers 120a, 120b defines a respective rail axis that is disposed relative to (e.g., intersections with) the other respective rail axis at an angle less than 180°. For example, as shown, the rail receivers 120a, 120b may be disposed along rail axes that are at about a right angle from each other. The angle of the pair of (e.g., neighboring) rail receivers 120a, 120b may be dependent at least in part on a shape of the inside perimeter of the animal whelping container. Each of the rail receivers 120a, 120b may be configured to maintain its respective rail at a minimum height. The minimum height may be about 1 cm, about 2 cm, about 5 cm, about 10 cm, about 12 cm, about 15 cm, about 20 cm, about 25 cm, about 30 cm, any value therein, and/or fall within a range having any values therein as endpoints. For example, in some embodiments the minimum height is about 6 cm. The connector body 104 can include four panels in some embodiments and may generally form a rectangular prism as shown. In some embodiments, the coupling panels 134a, 134b may be parallel to one another. A rail height greater than about 20 cm may have reduced usefulness in providing accessibility to the mother.

Each of the spacers 124a, 124b can extend from a center of the connector head 108. Each of the spacers 124a, 124b can be configured to maintain at least a minimum distance between the connector body and a wall of an animal whelping box. Each of the spacers 124a, 124b can be disposed opposite a corresponding rail receiver 120a, 120b. In some embodiments, at least one of the spacers 124a, 124b can be disposed on a common general side of at least one of the tongues 112a, 112b. The rail receiver 120a, 120b may be configured to receive a cross-sectional shape of corresponding rails. The cross-sectional shape of the rail receiver 120a, 120b may be generally rectangular (e.g., square), ovular (e.g., circular), triangular, other shape (e.g., hexagonal), and/or a combination of multiple basic shapes.

FIG. 2 shows a different top plan view of the rail connector 100 of FIG. 1. As shown, the protrusions 116a, 116b may each be disposed on opposite sides of the connector body 104. Additionally or alternatively, each of the sides of the connector body 104 may include smooth surfaces (e.g., not including a tongue or protrusion therein).

FIG. 3 shows a top plan view of an example rail connector 100 that includes a connector foot 130. The connector foot 130 can include one or more receiving panels 138a, 138b. The receiving panels 138a, 138b may include one or more coupling panels 134a, 134b. Each of the coupling panels 134a, 134b may include corresponding slots 146a and slots 146b. Each of the slots 146a and slots 146b may be configured to couple with a corresponding protrusions 116a, 116b described above. As shown in FIG. 3, the rail connector 100 may include four receiving panels 138a, 138b, two of which are coupling panels 134a, 134b. The connector foot 130 can include a base 142 that is disposed at a bottom of the connector foot 130. The base 142 may include an extended lip from the connector foot 130. The base 142 can be configured to provide additional support on a support surface (e.g., a floor, the ground). A cross-section of the base 142 may generally track a shape of a cross-section of the connector foot 130 above the base 142. In some embodiments, the base 142 can have a shape that corresponds to a corresponding support element (not shown). The shape can be rectangular, ovular, triangular, or some other shape. The connector foot 130 may be configured to generally fit around an exterior of the connector body 104. For example, the connector foot 130 may have an interior cross-sectional shape and/or dimension that is just slightly larger than an exterior cross-sectional shape and/or dimension of the connector body 104. Such a coupling may allow for reduced play between the elements, additional structural integrity, and/or better safety of the animal whelping container. FIG. 4 shows a different top plan view of the rail connector 100 of FIG. 3.

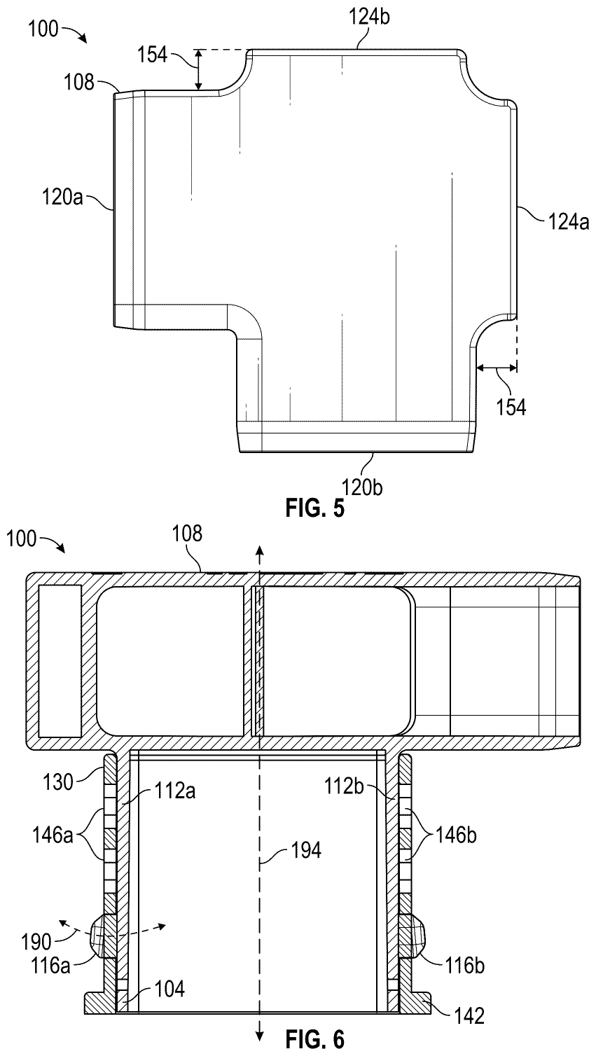

FIG. 5 shows a top view of the rail connector 100 shown in FIGS. 1-2. As shown, the spacers 124a, 124b can each extend a distance from a support axis of the connector head 108 (see FIG. 6) such that spacers 124a, 124b maintain at least a minimum distance 154 between the connector body and a wall of an animal whelping box. The spacers 124a, 124b can generally be flat to abut a flat wall and/or include a particular shape to couple to a shape of a corresponding wall. Maintaining the minimum distance 154 can help reduce damage to the whelping box and/or rails by reducing contact between the rails and the walls of the whelping box. Additionally or alternatively, maintaining this minimum distance 154 can help improve the protection the rail system provides the baby animals (e.g., from crushing or smothering by the mother). The minimum distance 154 may be about 0.25 cm, about 0.5 cm, about 0.75 cm, about 1 cm, about 1.5 cm, about 2 cm, about 3 cm, about 4 cm, about 5 cm, about 7 cm, about 8 cm, about 10 cm, about 15 cm, about 20 cm, any value therein, and/or fall within a range having any values therein as endpoints. For example, in some embodiments the minimum distance 154 is about 1.5 cm. Spacer distances greater than about 4 cm or 5 cm can be dangerous as this can create a gap between the walls of the whelping box and the guard rails that allows baby animals (e.g., dog pups) to get their heads caught in there.

FIG. 6 shows a side view of a cross-section of the rail connector 100 of FIGS. 3-4. The connector body 104 can couple to the connector foot 130 along a support axis 194. The tongues 112a, 112b can flex along a respective flexure arc 190. As shown, the flexure arc 190 of the tongues 112a, 112b, when the tongues 112a, 112b are in the closed configuration, is orthogonal to the support axis 194. The protrusions 116a, 116b can extend through a selected corresponding slot 146a, 146b such that the connector body 104 can be supported by the connector foot 130 (e.g., via the coupling between the protrusions 116a, 116b and corresponding slots 146a, 146b).

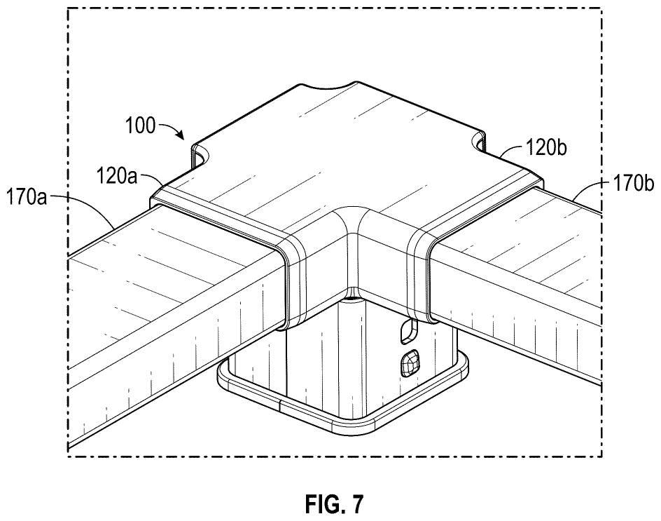

FIG. 7 shows the rail connector 100 of FIGS. 3-4 that includes rails 170a, 170b. The rails 170a, 170b can extend from corresponding rail receivers 120a, 120b. Each of the rails 170a, 170b can be generally have a shape of a rectangular prism. For example, a cross-section of each of the rails 170a, 170b may generally couple to (e.g., fit within) an opening of the rail receivers 120a, 120b. Each of the rails 170a, 170b may extend generally a full dimension (e.g., width, length) of the animal whelping box inside perimeter. In some embodiments, the rails 170a, 170b may be generally hollow and configured to be lightweight. Additionally or alternatively, the rails 170a, 170b may be configured to be sturdy and/or rigid. For example, the rails 170a, 170b may be made at least in part of hard plastic, wood, metal, or some other rigid material. Other options are possible.

Various implementations of the present disclosure may be a system, a method, and/or apparatus. Many variations and modifications may be made to the above-described implementations, the elements of which are to be understood as being among other acceptable examples. All such modifications and variations are intended to be included herein within the scope of this disclosure. The foregoing description details certain implementations. It will be appreciated, however, that no matter how detailed the foregoing appears in text, the systems and methods can be practiced in many ways. As is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

Conditional language, such as, among others, “can,” “could,” “might,” or “may,” unless specifically stated otherwise, or otherwise understood within the context as used, is generally intended to convey that certain implementations include, while other implementations do not include, certain features, elements, and/or steps. Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation.

Conjunctive language such as the phrase “at least one of X, Y, and Z,” or “at least one of X, Y, or Z,” unless specifically stated otherwise, is to be understood with the context as used in general to convey that an item, term, etc. may be either X, Y, or Z, or a combination thereof. For example, the term “or” is used in its inclusive sense (and not in its exclusive sense) so that when used, for example, to connect a list of elements, the term “or” means one, some, or all of the elements in the list. Thus, such conjunctive language is not generally intended to imply that certain implementations require at least one of X, at least one of Y, and at least one of Z to each be present.

The term “a” as used herein should be given an inclusive rather than exclusive interpretation. For example, unless specifically noted, the term “a” should not be understood to mean “exactly one” or “one and only one”; instead, the term “a” means “one or more” or “at least one,” whether used in the claims or elsewhere in the specification and regardless of uses of quantifiers such as “at least one,” “one or more,” or “a plurality” elsewhere in the claims or specification. The term “comprising” as used herein should be given an inclusive rather than exclusive interpretation.

While the above detailed description has shown, described, and pointed out novel features as applied to various implementations, it may be understood that various omissions, substitutions, and changes in the form and details of the devices or processes illustrated may be made without departing from the spirit of the disclosure. As may be recognized, certain implementations of the inventions described herein may be embodied within a form that does not provide all of the features and benefits set forth herein, as some features may be used or practiced separately from others. The scope of certain inventions disclosed herein is indicated by the appended claims rather than by the foregoing description. All changes which come within the meaning and range of equivalency of the claims are to be embraced within their scope.

### Example Embodiments

The following provides some example embodiments described above. The list below is by example only.

In a 1st Example, an animal whelping box rail connector comprises: a connector body comprising a plurality of tongues each biased in a closed configuration, each of the plurality of tongues configured to at least partially flex along a flexure arc between the closed configuration and an adjustable configuration, each of the plurality of tongues comprising a respective protrusion configured to couple to a corresponding slot in the closed configuration, wherein each of the plurality of tongues is disposed opposite another of the plurality of tongues relative to the connector body; a connector head comprising: a plurality of rail receivers each configured to receive a corresponding rail therein; and a plurality of spacers each disposed opposite a corresponding rail receiver of the plurality of rail receivers, each of the plurality of spacers configured to maintain at least a minimum distance between the connector body and a wall of an animal whelping box; and a connector foot configured to couple along a support axis to and support the connector body, the connector foot comprising a plurality of coupling panels, each of the plurality of coupling panels comprising a corresponding plurality of slots, wherein each of the plurality of slots of a coupling panel of the plurality of coupling panels is disposed at a respective height relative to a base of the foot, wherein each of the plurality of slots is configured to receive a corresponding protrusion of the connector body, wherein the connector body is configured to be adjustably couplable to the connector foot along the support axis when the plurality of tongues are in the adjustable configuration.

In a 2nd Example, the animal whelping box rail connector of Example 1, wherein the flexure arc of a tongue of the plurality of tongues is orthogonal to the support axis at the tongue in the closed configuration.

In a 3rd Example, the animal whelping box rail connector of any of Examples 1-2, wherein the connector foot comprises a plurality of receiving panels comprising the plurality of coupling panels, wherein a pair of the plurality of coupling panels are parallel to one another.

In a 4th Example, the animal whelping box rail connector of Example 3, wherein each of the plurality of rail receivers extends farther from a nearest surface of a corresponding receiving panels of the connector body than does each of the plurality of spacers.

In a 5th Example, the animal whelping box rail connector of Example 4, wherein each of the plurality of rail receivers extends farther than the minimum distance.

In a 6th Example, the animal whelping box rail connector of any of Examples 1-5, wherein the connector body, in the adjustable configuration, is configured to be adjustable in height relative to the connector foot.

In a 7th Example, the animal whelping box rail connector of Example 6, wherein the connector body is adjustable via adjustable coupling between each protrusion and a different slot of the corresponding plurality of slots.

In an 8th Example, the animal whelping box rail connector of any of Examples 1-7, farther comprising the corresponding plurality of rails.

In a 9th Example, an animal whelping box rail connector comprises: a connector body comprising a tongue biased in a closed configuration, the tongue configured to at least partially flex between the closed configuration and an adjustable configuration, the tongue comprising a protrusion configured to couple to a corresponding slot of a connector foot in the closed configuration; and a connector head comprising: a plurality of rail receivers each configured to receive a corresponding rail therein; and a plurality of spacers each disposed opposite a corresponding rail receiver of the plurality of rail receivers, each of the plurality of spacers configured to maintain at least a minimum distance between the connector body and a wall of an animal whelping box.

In a 10th Example, the animal whelping box rail connector of Example 9, wherein the connector body comprises a plurality of tongues each comprising a respective protrusion configured to couple to a corresponding slot.

In a 11th Example, the animal whelping box rail connector of Example 10, wherein each of the plurality of tongues is disposed opposite another of the plurality of tongues relative to the connector body.

In a 12th Example, the animal whelping box rail connector of any of Examples 9-11, farther comprising a connector foot configured to support the connector body.

In a 13th Example, the animal whelping box rail connector of Example 12, wherein the connector foot is configured to couple to the connector body along a support axis.

In a 14th Example, the animal whelping box rail connector of Example 13, wherein the connector body is configured to be adjustably couplable to the connector foot along the support axis when the tongue is in the adjustable configuration.

In a 15th Example, the animal whelping box rail connector of any of Examples 9-14, wherein the connector foot comprises a plurality of coupling panels, each of the plurality of coupling panels comprising a corresponding plurality of slots, wherein at least one of the plurality of coupling panels is configured to couple to the tongue of the connector body.

In a 16th Example, the animal whelping box rail connector of Example 15, wherein the at least one coupling panel comprises at least one slot configured to receive the protrusion of the connector body.

In a 17th Example, the animal whelping box rail connector of Example 15, wherein the connector foot comprises a plurality of receiving panels comprising the plurality of coupling panels, wherein a pair of the plurality of coupling panels are parallel to one another.

In a 18th Example, the animal whelping box rail connector of any of Examples 9-17, wherein the at least one slot comprises a plurality of slots plurality of slots each disposed at a respective height relative to a base of the foot.

In a 19th Example, the animal whelping box rail connector of any of Examples 9-18, wherein each of the plurality of rail receivers extends farther from a nearest surface of a corresponding receiving panels of the connector body than does each of the plurality of spacers.

In a 20th Example, the animal whelping box rail connector of Example 19, wherein each of the plurality of rail receivers extends farther than the minimum distance.

In a 21st Example, the animal whelping box rail connector of any of Examples 9-20, wherein the connector body, in the adjustable configuration, is configured to be adjustable in height relative to the connector foot.

In a 22nd Example, the animal whelping box rail connector of Example 21, wherein the connector body is adjustable via adjustable coupling between each protrusion and a different slot of the corresponding plurality of slots.

In a 23rd Example, the animal whelping box rail connector of any of Examples 9-22, farther comprising the corresponding plurality of rails.

What is claimed is:

1. An animal whelping box rail connector comprising:
a connector body comprising a plurality of tongues each biased in a closed configuration, each of the plurality of tongues configured to at least partially flex along a flexure arc between the closed configuration and an adjustable configuration, each of the plurality of tongues comprising a respective protrusion configured to couple to a corresponding slot in the closed configuration, wherein each of the plurality of tongues is disposed opposite another of the plurality of tongues relative to the connector body;
a connector head comprising:
a plurality of rail receivers each configured to receive a corresponding rail therein; and
a plurality of spacers each disposed opposite a corresponding rail receiver of the plurality of rail receivers, each of the plurality of spacers configured to maintain at least a minimum distance between the connector body and a wall of an animal whelping box; and
a connector foot configured to couple along a support axis to and support the connector body, the connector foot comprising a plurality of coupling panels, each of the plurality of coupling panels comprising a corresponding plurality of slots, wherein each of the plurality of slots of a coupling panel of the plurality of coupling panels is disposed at a respective height relative to a base of the foot, wherein each of the plurality of slots is configured to receive a corresponding protrusion of the connector body, wherein the connector body is configured to be adjustably couplable to the connector foot along the support axis when the plurality of tongues are in the adjustable configuration.

2. The animal whelping box rail connector of claim 1, wherein the flexure arc of a tongue of the plurality of tongues is orthogonal to the support axis at the tongue in the closed configuration.

3. The animal whelping box rail connector of claim 1, wherein the connector foot comprises a plurality of receiving panels comprising the plurality of coupling panels, wherein a pair of the plurality of coupling panels are parallel to one another.

4. The animal whelping box rail connector of claim 3, wherein each of the plurality of rail receivers extends farther from a nearest surface of a corresponding receiving panels of the connector body than does each of the plurality of spacers.

5. The animal whelping box rail connector of claim 4, wherein each of the plurality of rail receivers extends farther than the minimum distance.

6. The animal whelping box rail connector of claim 1, wherein the connector body, in the adjustable configuration, is configured to be adjustable in height relative to the connector foot.

7. The animal whelping box rail connector of claim 6, wherein the connector body is adjustable via adjustable coupling between each protrusion and a different slot of the corresponding plurality of slots.

8. The animal whelping box rail connector of claim 1, farther comprising the corresponding plurality of rails.

9. An animal whelping box rail connector comprising:
a connector body comprising a tongue biased in a closed configuration, the tongue configured to at least partially flex between the closed configuration and an adjustable configuration, the tongue comprising a protrusion configured to couple to a corresponding slot of a connector foot in the closed configuration; and
a connector head comprising:
a plurality of rail receivers each configured to receive a corresponding rail therein; and
a plurality of spacers each disposed opposite a corresponding rail receiver of the plurality of rail receivers, each of the plurality of spacers configured to maintain at least a minimum distance between the connector body and a wall of an animal whelping box.

10. The animal whelping box rail connector of claim 9, wherein the connector body comprises a plurality of tongues each comprising a respective protrusion configured to couple to a corresponding slot.

11. The animal whelping box rail connector of claim 10, wherein each of the plurality of tongues is disposed opposite another of the plurality of tongues relative to the connector body.

12. The animal whelping box rail connector of claim 9, farther comprising a connector foot configured to support the connector body.

13. The animal whelping box rail connector of claim 12, wherein the connector foot is configured to couple to the connector body along a support axis.

14. The animal whelping box rail connector of claim 13, wherein the connector body is configured to be adjustably couplable to the connector foot along the support axis when the tongue is in the adjustable configuration.

15. The animal whelping box rail connector of claim 9, wherein the connector foot comprises a plurality of coupling panels, each of the plurality of coupling panels comprising a corresponding plurality of slots, wherein at least one of the plurality of coupling panels is configured to couple to the tongue of the connector body.

16. The animal whelping box rail connector of claim 15, wherein the at least one coupling panel comprises at least one slot configured to receive the protrusion of the connector body.

17. The animal whelping box rail connector of claim 15, wherein the connector foot comprises a plurality of receiving panels comprising the plurality of coupling panels, wherein a pair of the plurality of coupling panels are parallel to one another.

18. The animal whelping box rail connector of claim 9, wherein the at least one slot comprises a plurality of slots plurality of slots each disposed at a respective height relative to a base of the foot.

19. The animal whelping box rail connector of claim 9, wherein each of the plurality of rail receivers extends farther from a nearest surface of a corresponding receiving panels of the connector body than does each of the plurality of spacers.

20. The animal whelping box rail connector of claim 19, wherein each of the plurality of rail receivers extends farther than the minimum distance.
